(19) United States
(12) Patent Application Publication
(10) Pub. No.: US 2014/0075363 A1
(43) Pub. Date: Mar. 13, 2014

(54) Context Aware Non-Linear Task Bar Orientation

(71) Applicants: Barry A. Kritt, Research Triangle Park, NC (US); Sarbajit K. Rakshit, Kolkata (IN)

(72) Inventors: Barry A. Kritt, Research Triangle Park, NC (US); Sarbajit K. Rakshit, Kolkata (IN)

(73) Assignee: INTERNATIONAL BUSINESS MACHINES CORPORATION, Armonk, NY (US)

(21) Appl. No.: 13/613,005

(22) Filed: Sep. 13, 2012

(51) Int. Cl. G06F 3/048

(52) U.S. Cl. 715/772

(57) ABSTRACT

A contextually sensitive visual display for active applications and open files. Active applications and open files are semantically analyzed, ranked and presented in a hierarchical orientation responsive to the ranking. A primary interface is divided into primary sections, with each active application assigned a primary section corresponding to its rank. Open files are similarly hierarchically oriented in a secondary interface divided into secondary sections and in communication with a primary section containing an active application associated with the open files.

### BACKGROUND

1. Technical Field

The present invention relates to a method and system for orientation of a task bar. More specifically, the invention relates to a system and method that combines real-time context comparison to visually display active applications responsive to the comparison.

2. Description of the Prior Art

It is known in the art of computing to multi-task, where two or more applications may be active at a single time, and each application may have more than one file open at a single time. By having multiple applications and files open at the same time, information may be interchangeable between open applications, thereby creating efficiency in task management. Current operating systems are known to employ a graphical display with active applications linearly arranged, and open files within each active application arranged as thumbnails adjacent to a selected application. Selection of one of the active applications results in presentation of a thumbnail of each open file associated with the active application. An open file may be selected from the thumbnail presentation. Accordingly, the task bar and thumbnail presentation of applications and files, respectively, employ a linear arrangement of active applications and open files.

As the quantity of active applications and open files increases, the presentation is linearly extended. This linear extension is challenging, if not impossible, for a viewer to review an entire list of active applications and files. Accordingly, there is a burden associated with selecting or viewing applications and associated files with the linear task bar arrangement.

### SUMMARY OF THE INVENTION

A method, system, and computer program product for semantically analyzing active applications and open files and presenting the active applications and open files responsive to the semantic analysis.

In one aspect, a method is provided for a relevance sensitive presentation of active applications. Information is extracted from two or more active applications, and an activity associated with the extracted information is identified. More specifically, the identification includes a semantic analysis of current activities associated with the active applications. The active applications are ranked in response to the semantic analysis of the current activity. The ranked applications are visually displayed in a first interface, including assigning each of the active application(s) to a designated area in the first interface responsive to the ranking.

In another aspect, a system is provided with a processing unit to support execution of two or more applications. A functional unit is provided in communication with the processing unit and employs tools to support an interface with the applications. The tools include, but are not limited to, an extraction manager, an activity manager, a rank manager, and a display manager. The extraction manager functions to extract information from the two or more active applications. The activity manager functions to identify an activity associated with the extracted information. Specifically, current activity associated with the active applications is semantically analyzed by the activity manager. The rank manager ranks the active applications in response to the semantic analysis of the current activity by the activity manager. The display manager visually presents the ranked applications in a first interface, with the visual presentation including an assignment of one or more higher ranked applications responsive to the ranking.

In yet another aspect, a computer program product for use with electronic communication data is provided. The computer program product includes a computer readable non-transitory storage medium having computer readable program code embodied thereon, which when executed causes a computer to implement a method for intuitively displaying applications. The computer program product extracts information from active applications, and identifies an activity associated with the extracted information. Specifically, the program product semantically analyzes current activity associated with one or more of the active applications. The active applications are ranked responsive to the semantic analysis of the current activity and visually displayed in a first interface responsive to the ranking.

In an even further aspect, a method is provided for a relevance sensitive presentation of active applications. Information is extracted from two or more active applications, and an activity associated with the extracted information is identified. More specifically, the identification includes a semantic analysis of current activities associated with the active applications. The active applications are ranked in response to the semantic analysis of the current activity. The ranked applications are displayed in a first visual interface, including having a separate section allocated for assignment of each active application and a size of each section allocated in response to the ranking of the assigned application.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a block diagram of prior art for a linear display of applications and files.

FIG. 2 is a flow chart illustrating a method to visually display ranked applications and ranked files.

FIG. 3 is an illustrative drawing for a non-linear display of ranked files.

FIG. 4 is an illustrative drawing for an embodiment of a non-linear display of ranked files.

FIG. 5 is an illustrative drawing of an embodiment of the invention for a non-linear display of ranked applications and files.

FIG. 6 is a block diagram of an embodiment of the invention for an alternative display of ranked applications and files.

FIG. 7 is a block diagram illustrating tools embedded in a system to support a visual display sensitive to active applications and open file rankings.

FIG. 8 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

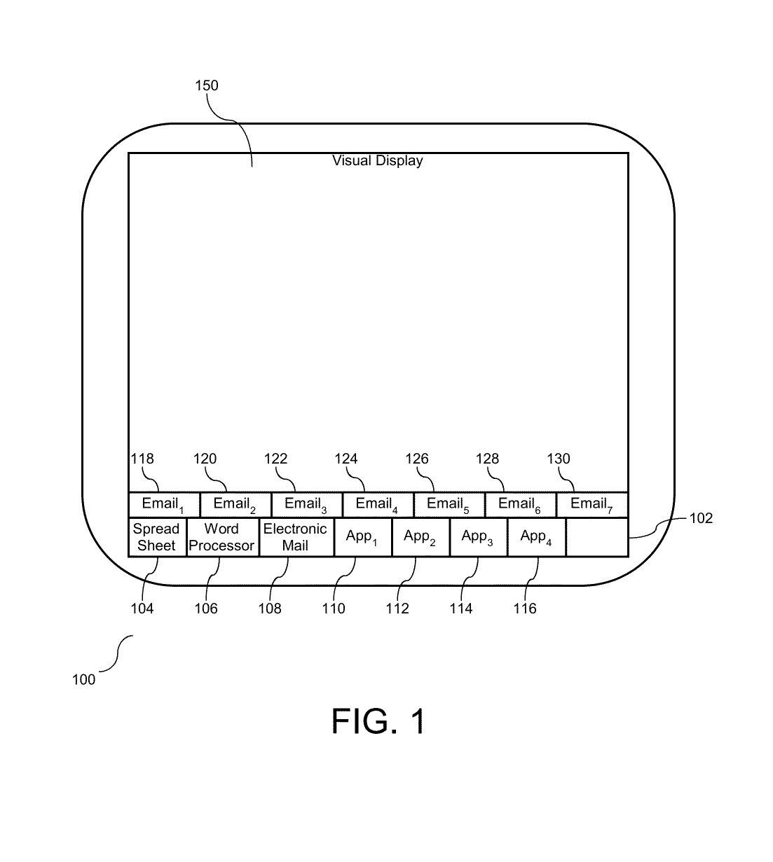

FIG. 1 is a prior art block diagram (100) depicting an interface for displaying applications and files. Active applications are displayed in a window of a visual display (150). In the example shown in FIG. 1, displayed applications are grouped linearly in an interface, e.g. a taskbar of the operating system (102). Any number of open files within an active application may be opened simultaneously. These files are displayed linearly as thumbnails (118)-(130) often in response to scrolling over an active application in the taskbar (102) with an input device e.g. a cursor. In the example shown in FIG. 1, the files are in the form of electronic messages, (118)-(130) respectively, opened through an electronic mail storage application (108). The linear orientation of the application(s) and file(s) can be undesirable as it does not prioritize any of the applications or files. Furthermore, the display can force a user to travel inconvenient distances with an input device on the visual display (150) when opening applications, thereby preventing switching quickly between applications and files. Accordingly, the display shown herein has limitations pertaining to the efficiency of application and file management.

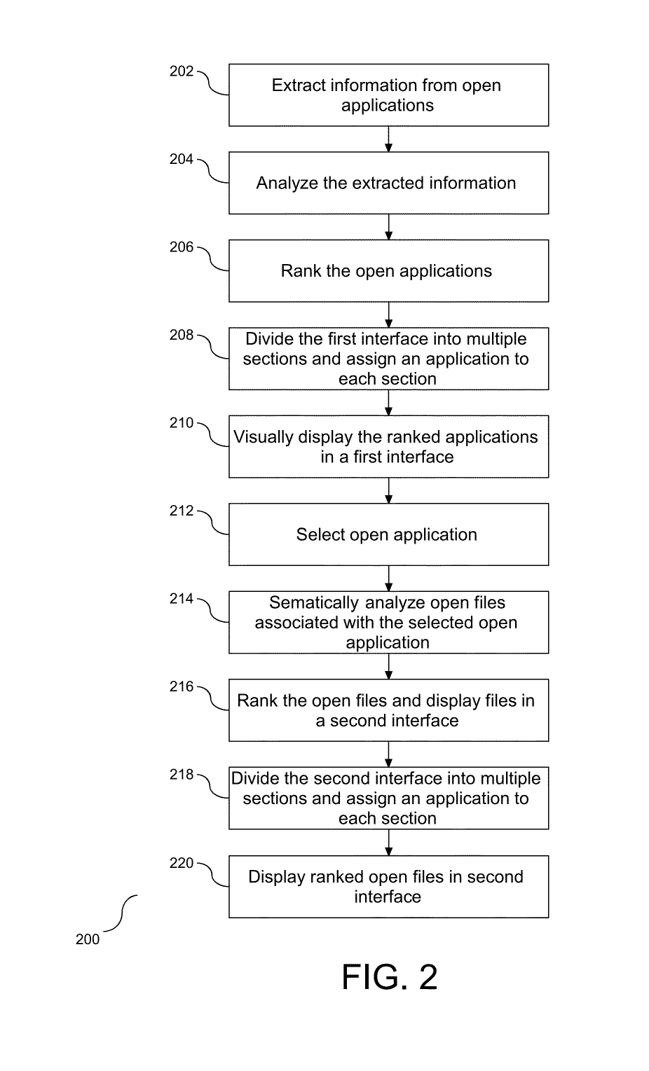

FIG. 2 is a flow chart (200) illustrating a method for displaying active applications and open files in an interface. Information is extracted from active applications (202). This information includes descriptive details about the active applications. In one embodiment, these details include but are no limited to, the content of the application, how recently an active application was used, how frequently an application is used, and/or how active a user is within an application. An application is analyzed based on the extracted information (204) and then ranked (206). The ranking of an active application may be based on a determination of importance and/or relevance from the application analysis (204). For example, a first application used more frequently and more recently than a second application could be determined to be more important than the second application and would subsequently be given a higher ranking than the second application. Accordingly, active applications are ranked based on inherent characteristics, and a comparison of the characteristics with multiple sections, each section having an assigned application.

A first interface is divided into multiple primary sections with an active application assigned to each section (208). In one embodiment, the interface is oriented in a non-linear format, such as a circle or pie chart. In another embodiment, the orientation of the display is a vertical arrangement of applications and/or files. The location and size of a section to which an active application is assigned is contingent upon the rank of the active application. For example, an active application given a higher ranking could be placed closer to an input device, such as the cursor. In one embodiment, the size of each section is proportional to the ranking of each corresponding active application. Accordingly, applications of higher ranking are allocated sections that provide easier access and larger space.

Following the assignment of active applications to primary sections, or divisions of the first interface (212), any one of the active applications may be selected. Two or more open files associated with the selected active application are semantically analyzed (214). More specifically, information is extracted from the open files, and the open files are analyzed and ranked based on the extracted information (216). In one embodiment, the ranking is based on details such as, the content of the open file including similarity of content to other open files, how recently an open file was used, how frequently an open file is used, and/or how active a user is within the open file. In one embodiment, the analysis of the content of the open file could include the graphical, pictorial, and or audio content of the file. For example, an open file containing an image could be analyzed to identify objects in the image. Other files containing photos of the same or similar objects could be ranked higher because those files could be considered contextually similar. Accordingly, open files are analyzed and ranked based on the analysis.

A secondary interface is provided in communication with the primary interface, with the secondary interface related to the selected active application. The orientation of the secondary interface may be different or of like shape and style to the primary interface. In one embodiment the secondary interface is a circle or a pie chart. In another embodiment this interface comprises one or more vertical columns. The secondary interface is divided into multiple secondary sections and each open file associated with the selected and active application is assigned a corresponding secondary section (218). The secondary section to which an open file is assigned is contingent upon the rank of the open file. In one embodiment, the size of each secondary section is proportional to the ranking of each corresponding open file. In another embodiment, the location of each secondary section is relative to the ranking of each corresponding open file. In a further embodiment, the assignment of an open file to a secondary section is based on the orientation of the secondary section. The ranked open files are visually displayed in the secondary interface (220). Accordingly, a context aware presentation of active applications and open files is displayed for navigation.

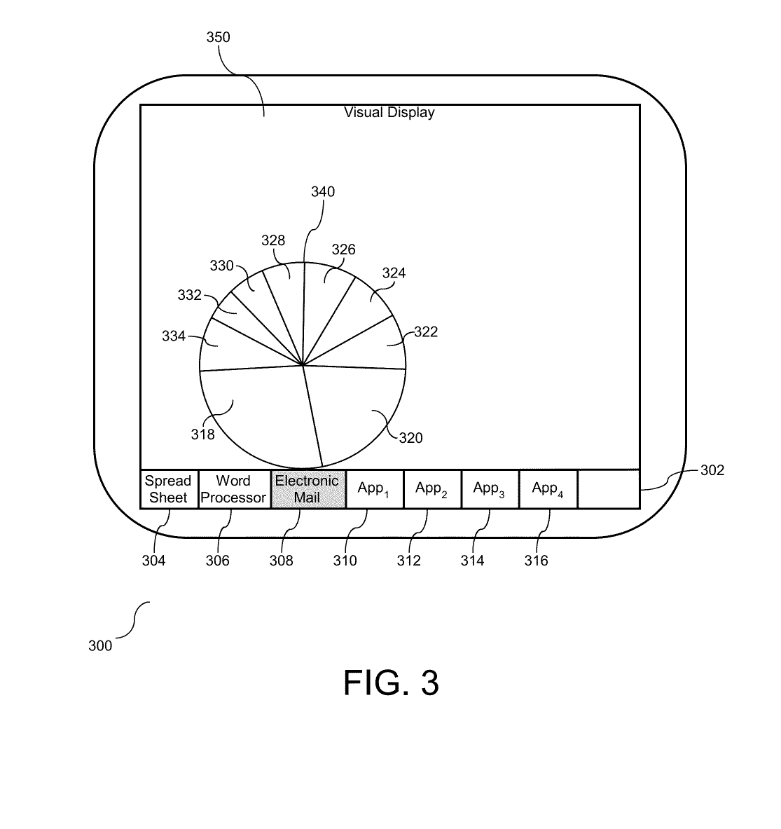

FIG. 3 is an illustrative drawing (300) depicting an interface for intuitively and/or semantically displaying applications and files. Active applications, or applications that are running, are displayed in a window of a visual display (350). The active applications are ranked and each application is assigned to a section on a primary interface e.g. a task bar (302). The applications are divided linearly in a ranked order. In one embodiment, the primary section an active application is allotted on the task bar (302) varies in size based on the ranking of an active application, allocating a greater amount of space to a higher ranked application. The ranking of the applications could be based on a grouping of applications determined to be related, and/or the importance of an application.

Open files are displayed (318)-(334) in a secondary interface in a non-linear orientation (340) divided into secondary sections of varying sizes based on rank. In the example shown herein, the application is an electronic mail application (308) and each file represents an electronic mail message (318)-(334). In one embodiment, electronic mail messages determined to have a contextual relationship are placed in adjacent sections of the secondary interface (340). For example, electronic mail message₁ (318) is determined to be contextually related to, and have a higher ranking than, electronic mail message₂ (320). Electronic mail message₁ (318) is allocated a larger displayed section of the circular secondary interface (340) and is placed in an adjacent section to electronic mail message₂ (320) within the interface (340). Additionally, as in one embodiment of the invention, electronic mail message₁ (318) and electronic mail message₂ (320) are ranked higher than electronic mail messages (322)-(334) respectively, and are thus placed closer to the primary section of the electronic message storage application (308) than electronic messages (322)-(334). Accordingly, the provided display is sensitive to application and file context as well as user priority, allowing for an efficient and intuitive form of navigation.

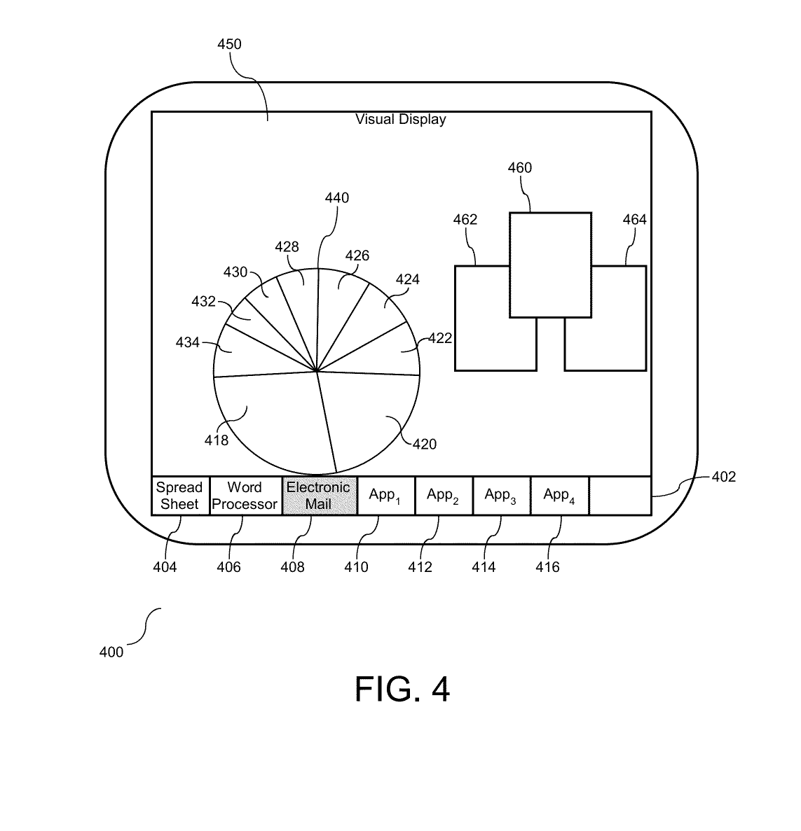

FIG. 4 is an illustrative drawing (400) of one embodiment of a visual display in which all elements of FIG. 3 are incorporated therein and referenced with like numbers. A first open file (460) is displayed having the main foreground focus in the visual display. In one embodiment, the first open file (460) is displayed having the main foreground focus because it is the most recently selected application. A second open file (462) and a third open file (464) are displayed in the background and are of secondary focus. In one embodiment, only one file is displayed having the main foreground focus at any given time while any number of files can be displayed having a secondary focus. In one embodiment, applications and/or files are ranked more heavily according to the semantic relationship the applications and/or files has with the file having the main foreground focus (460), than the file(s) having the secondary or background focus, (462) and (464) respectively. For example, electronic mail message₁ (418) may be assigned the largest secondary section because it is considered semantically related to open file (460) and was therefore ranked accordingly. In one embodiment, an application and/or file having a semantic relationship with a file in the main foreground (460) and a file in the secondary or background focus (462) could be ranked higher than an application and/or file having a semantic relationship with only one of (460), (462), or (464). Accordingly, the ranking of files is based off of a number of factors, including a possible dependency on files having a main foreground focus and files having a secondary focus.

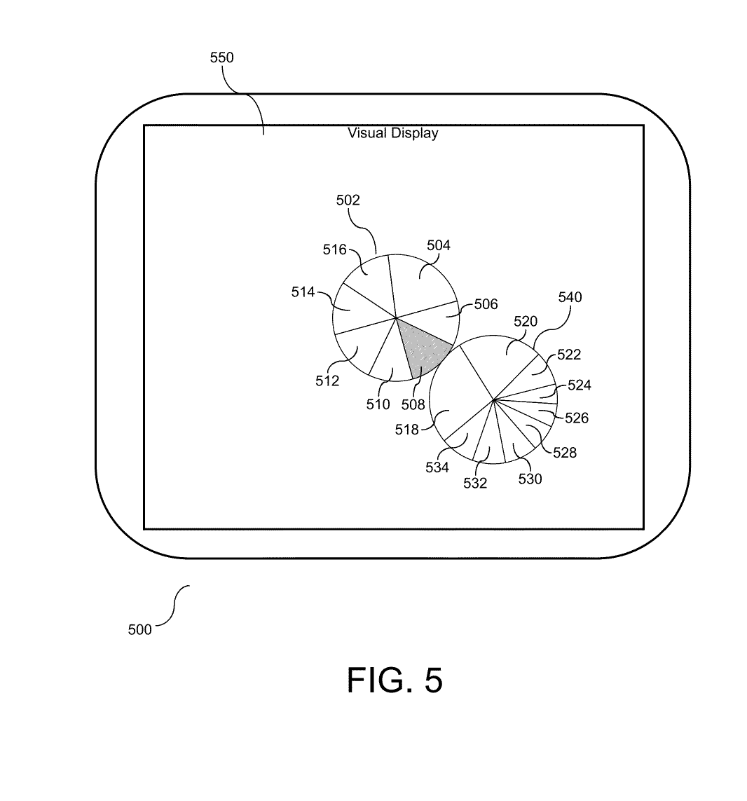

FIG. 5 is an illustrative drawing (500) depicting one embodiment of the interface. Ranked applications, (504)-(516) respectively, are represented on a primary interface having a non-linear orientation (502). The primary interface is divided into multiple sections of varying sizes with each application designated to a single section in the primary interface. Active applications are ranked and hierarchically organized based on the ranking. Applications with higher ranking such as application₁ (504) are assigned to larger sections of the primary interface (502) than applications with a lower ranking in the hierarchy, such as application₅ (512). Accordingly, applications are ranked and displayed in corresponding sections of the interface.

One or more open files contained within an application are displayed in a secondary interface (540) in communication with the primary section of the parent application. Similar to the primary interface (502), the secondary interface (540) is divided into secondary sections of varying sizes, with greater sized sections assigned to files of higher ranking. In the example shown herein, electronic mail messages, (518)-(534) respectively, are represented in the secondary interface (540) in communication with the primary display section allocated to an electronic message storage application (508). As depicted, electronic mail message₁ (518) is determined to be contextually related to, and have a higher ranking than, electronic mail message₂ (520) and is therefore allocated a larger displayed section of the circular secondary interface than electronic mail message₂ (520). Additionally, electronic mail message₁ (518) is placed in an adjacent section to electronic mail message₂ (520) within the interface due to their contextual relationship. Electronic mail message₁ (518) and electronic mail message₂ (520) are ranked higher than electronic mail messages (522-534) respectively, and are thus placed closer to the primary section of the electronic message storage application (508) than electronic mail messages (522)-(534). Accordingly, FIG. 4 illustrates a display having a non-linear orientation for intuitive navigation, sensitive to application and file context as well as priority.

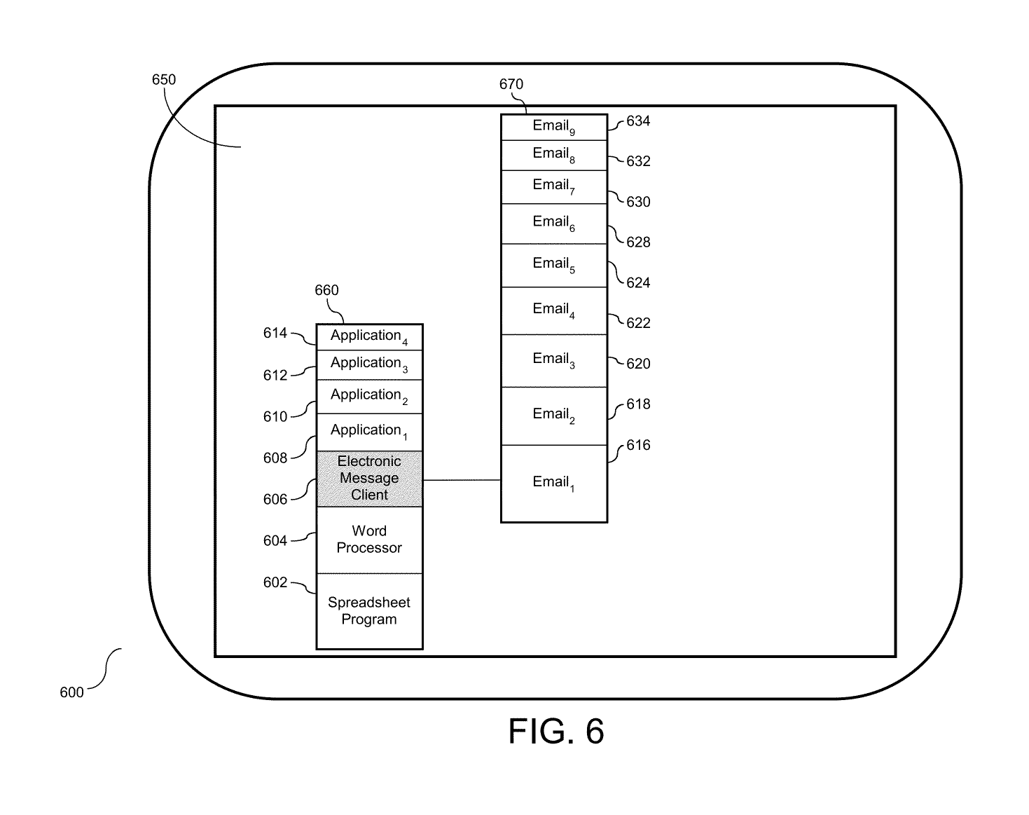

FIG. 6 is a block diagram (600) of one embodiment of the interface in which ranked applications and files are hierarchically organized in vertical columns. In the example, active applications (602)-(614) are ranked and are displayed in divided sections of a first interface vertical orientation (660). The primary sections, or divisions of the first interface, vary in size and are divided such that applications of higher ranking are placed lower in the visual display (650) and are allocated larger primary space in the first interface. In one embodiment, the rankings may be inverted, such that applications of higher ranking are placed higher in the visual display (650) and are allocated space responsive to the ranking. A secondary interface (670) of vertical orientation is shown having at least one open file in communication with a primary section (606) of the primary interface (660) containing the application to which the open files are associated. The secondary interface (670) is divided into multiple secondary sections of a hierarchical structure. In the example, the open files are in the form of electronic messages (616)-(634). The sections assigned to the electronic messages vary in size with the highest ranked electronic message, electronic message₁ (616), allocated the greatest amount of space in the second interface (670). Open files are further ordered such that the higher the ranking of the open file, the closer the open file is placed to the primary section in the primary interface (660) containing the application corresponding to the open file. In the example, electronic message₁ (616) is ranked highest and is placed closest to the electronic message storage application (606). Accordingly, a display with ranked and ordered active applications and open files is provided for intuitive navigation.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

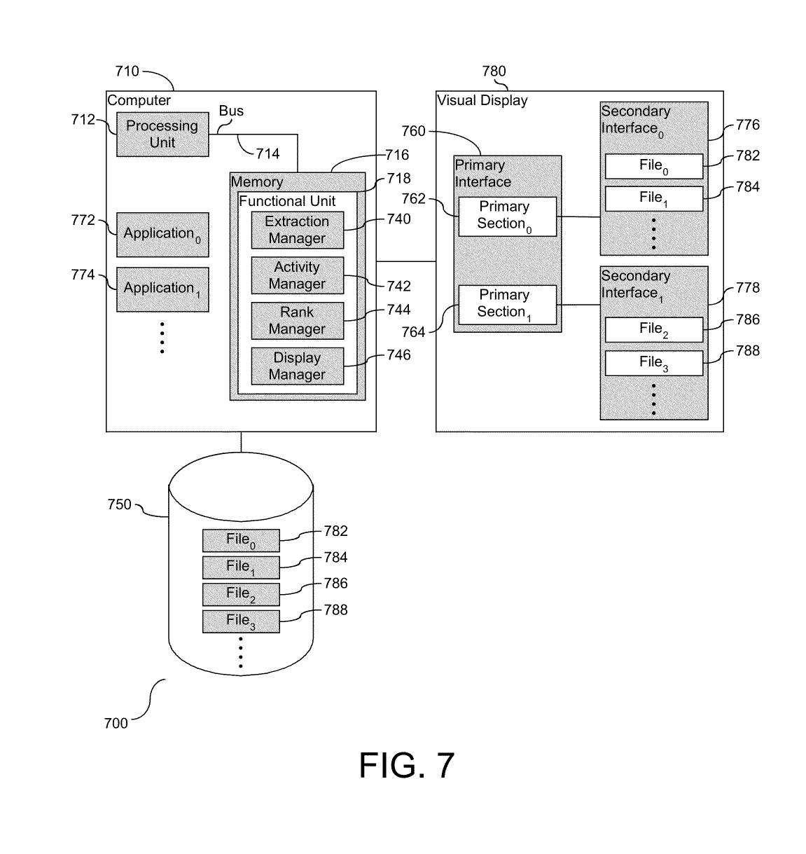

FIG. 7 is a block diagram (700) for displaying active applications and open files in response to the ranking of the active applications and open files. A computer is provided (710) in communication with data storage (750). The computer can be in communication with any number of data storage systems accessed locally or alternatively across a network. Storage system (750) contains any number of files and in this embodiment, contains files (782)-(784). The computer (710) is shown having a processing unit (712) in communication with memory (716) across a bus (714). A functional unit (718) is provided in communication with the processing unit (712) having tools embedded therewith to support context awareness with respect to task bar orientation. The tools may include but are not limited to, an extraction manager (740) to extract information from each of the active applications, and an activity manager (742) in communication with the extraction manager to identify an activity associated with the extracted information, including the activity manager to semantically analyze a current activity associated with the active applications. In addition, a rank manager (744) is provided in communication with the activity manager (742) to rank the applications in response to the semantic analysis of the current activity by the activity manager (742). In one embodiment, the rank manager (744) ranks the applications based on real-time content analysis, including ranking application based on relevance aspects such as the frequency of use of an application, how actively an application is used, how recently an application is used, or any combination of these aspects.

A display manager (746) is provided in communication with the rank manager (744). The display manager visually displays the ranked applications on a visual display (780). More specifically, the display manager (746) visually displays the ranked applications in a first interface (760), which in one embodiment is non-linear, on the visual display (780). The display manager (746) assigns each ranked application to a designated area in the primary interface (760) responsive to the ranking assessed by the rank manager (744). In one embodiment, the designated areas are primary sections (762)-(764) or divisions of the primary interface (760). While two primary sections are displayed (762)-(764), the display manager (746) can display any number of primary sections and in one embodiment, the display manager (746) displays one assigned primary section for each active application. In one embodiment, the display manager (746) allocates a size for each of the primary sections in the first interface responsive to the ranking of active applications. For example, application° (772) has a higher ranking than application₁ (774), therefore the display manager (746) allocates a larger size for the primary section assigned to application° (762) than the primary section assigned to application₁ (764). In a further embodiment, the display manager (746) allocates an application to a primary section having a specific location responsive to the ranking of assigned applications. For example, the display manager (746) may display an application of higher ranking in a primary section closer to an input device than an application having lower ranking. Accordingly, the active applications are assigned appropriate primary sections corresponding to the ranking of each active application.

In one embodiment, the extraction manager (740) selects an active application from the primary interface (760), and extracts information from two or more open files associated with the selected application. The activity manager (742) uses this extracted information to semantically analyze current activity associated with two or more open files. The ranking manager (744) ranks the two or more open files based on the semantic analysis of the activity manager (742). The display manager (746) visually displays the ranked open files in secondary sections, or divisions of the secondary interface, in communication with the primary interface (760). More specifically, each secondary interface (776)-(778) displays open files associated with one active application, and each secondary interface (776)-(778) is in communication with the primary section of the first interface allocated to the associated active application. For example, secondary interface (776) is shown with files (782) and (784), and secondary interface (778) is shown with files (786) and (788). In one embodiment, a secondary interface is displayed for every primary section of the primary interface. In one embodiment, the display manager (746) divides each secondary interface into multiple secondary sections, assigning each open file to one of the multiple secondary sections. The display manager (746) allocates a size to each of the secondary sections responsive to the ranking of the open files. For example, file₀ (782) is given a higher ranking by the rank manager than file₁ (784), therefore, the display manager (746) assigns file₀ (782) to a larger secondary section in the secondary interface than file₁ (784). Accordingly, open files are displayed corresponding to rank and in communication with associated ranked applications.

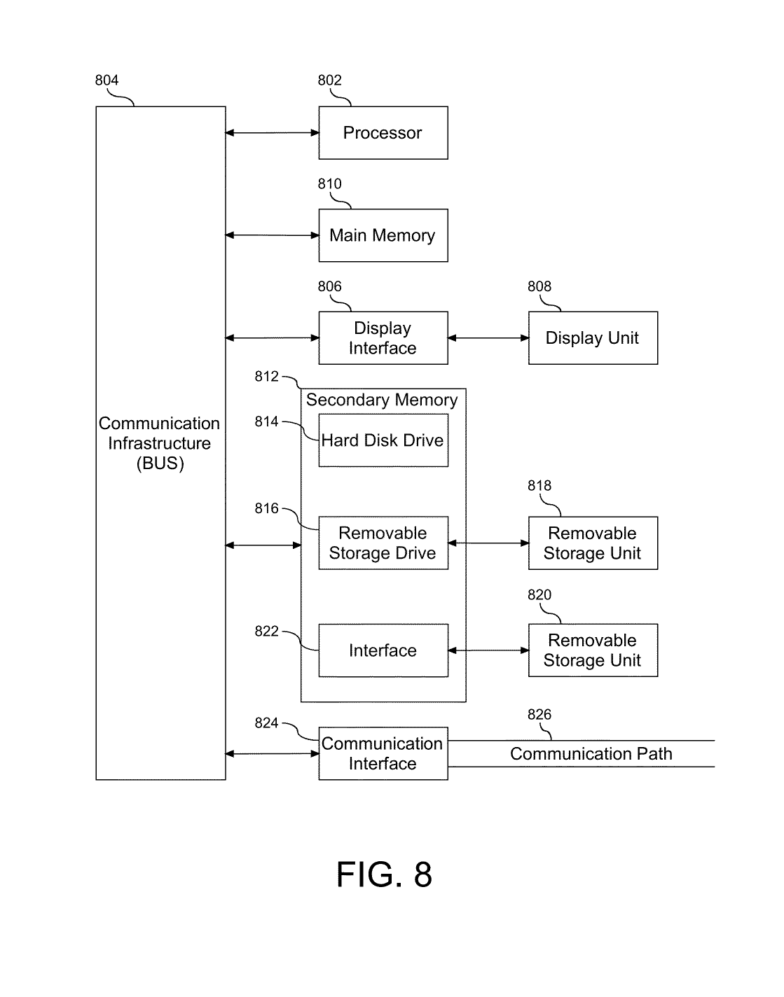

Referring now to the block diagram (800) of FIG. 8, additional details are now described with respect to implementing an embodiment of the present invention. The computer system includes one or more processors, such as a processor (802). The processor (802) is connected to a communication infrastructure (804) (e.g., a communications bus, cross-over bar, or network).

The computer system can include a display interface (806) that forwards graphics, text, and other data from the communication infrastructure (804) (or from a frame buffer not shown) for display on a display unit (808). The computer system also includes a main memory (810), preferably random access memory (RAM), and may also include a secondary memory (812). The secondary memory (812) may include, for example, a hard disk drive (814) (or alternative persistent storage device) and/or a removable storage drive (816), representing, for example, a floppy disk drive, a magnetic tape drive, or an optical disk drive. The removable storage drive (816) reads from and/or writes to a removable storage unit (818) in a manner well known to those having ordinary skill in the art. Removable storage unit (818) represents, for example, a floppy disk, a compact disc, a magnetic tape, or an optical disk, etc., which is read by and written to by a removable storage drive (816). As will be appreciated, the removable storage unit (818) includes a computer readable medium having stored therein computer software and/or data.

In alternative embodiments, the secondary memory (812) may include other similar means for allowing computer programs or other instructions to be loaded into the computer system. Such means may include, for example, a removable storage unit (820) and an interface (822). Examples of such means may include a program package and package interface (such as that found in video game devices), a removable memory chip (such as an EPROM, or PROM) and associated socket, and other removable storage units (820) and interfaces (822) which allow software and data to be transferred from the removable storage unit (820) to the computer system.

The computer system may also include a communications interface (824). Communications interface (824) allows software and data to be transferred between the computer system and external devices. Examples of communications interface (824) may include a modem, a network interface (such as an Ethernet card), a communications port, or a PCMCIA slot and card, etc. Software and data transferred via communications interface (824) are in the form of signals which may be, for example, electronic, electromagnetic, optical, or other signals capable of being received by communications interface (824). These signals are provided to communications interface (824) via a communications path (i.e., channel) (826). This communications path (826) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (810) and secondary memory (812), removable storage drive (816), and a hard disk installed in hard disk drive or alternative persistent storage device (814).

Computer programs (also called computer control logic) are stored in main memory (810) and/or secondary memory (812). Computer programs may also be received via a communication interface (824). Such computer programs, when run, enable the computer system to perform the features of the present invention as discussed herein. In particular, the computer programs, when run, enable the processor (802) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Specifically, the semantic analysis may include a contextual evaluation of the application and/or associated file such that the primary and/or secondary interface(s) provide for a contextually aware presentation. Accordingly, the scope of protection of this invention is limited only by the following claims and their equivalents.

1. (canceled)

2. (canceled)

3. (canceled)

4. (canceled)

5. (canceled)

6. (canceled)

7. (canceled)

8. (canceled)

9. A system comprising:
a processing unit to support execution of two or more applications;
a functional unit in communication with the processing unit, the functional unit having tools to support an interface with the applications, the tools comprising:
an extraction manager to extract information from the applications;
an activity manager to identify an activity associated with the extracted information, including semantic analysis of current activity associated with the applications;
a rank manager to rank the applications in response to the semantic analysis of the current activity by the activity manager; and
a display manager to visually display the ranked applications in a first interface, including each ranked application assigned to a designated area responsive to the rank manager.

10. The system of claim 9, wherein the ranked applications are visually displayed in a first interface having a non-linear orientation.

11. The system of claim 9, further comprising the display manager to divide the first interface into multiple primary sections, and assign each active application to one of the multiple primary sections.

12. The system of claim 11, further comprising the display manager to allocate a size of each of the primary sections in the first interface responsive to the rank of the assigned application.

13. The system of claim 11, wherein the assignment of the application to one of the multiple primary sections includes assignment of a higher ranked application to a primary section closest to an input device.

14. The system of claim 9, further comprising extraction manager to select an active application from the first interface, and extract information from two or more open files associated with the selected active application, including the activity manager to semantically analyze current activity associated with the two or more open files.

15. The system of claim 14, further comprising the rank manager to rank the open files responsive to the semantic analysis, and the display manager to visually display the ranked files responsive to the rank in a second interface in communication with the first interface.

16. The system of claim 15, further comprising:
the file manager to divide the second interface into multiple secondary sections, assign each open file to one of the multiple secondary sections, and allocate a size of each of the secondary sections responsive to the ranking of the file; and
the ranking manager to rank the applications based on real-time content analysis selected from the group consisting of: most recently use, most actively used, frequency of use, and combinations thereof.

17. A computer program product for use with electronic communication data, the computer program product comprising a computer-readable non-transitory storage medium having computer readable program code embodied thereon, which when executed causes a computer to implement a method comprising:
extracting information from two or more active applications;
identifying an activity associated with the extracted information, including semantically analyzing current activity associated with one or more of the active applications;
ranking the active applications responsive to the semantic analysis of the current activity; and
visually displaying the ranked applications in a first interface having a first non-linear orientation responsive to the ranking.

18. The computer program product of claim 17, further comprising dividing the first interface into multiple primary sections, and assigning each active application to one of the multiple primary sections.

19. The computer program product of claim 18, further comprising allocating a size of each of the primary sections in the first interface responsive to the ranking of the assigned application.

20. The computer program product of claim 18, wherein the assignment of the application to one of the multiple primary sections is responsive to the ranking, including assigning a higher ranked application closest to an input device.

21. The computer program product of claim 17, further comprising selecting an active application from the first interface, and extracting information from two or more open files associated with the selected active application, including semantically analyzing current activity associated with the two or more open files.

22. The computer program product of claim 21, further comprising ranking the open files responsive to the semantic analysis, and visually displaying the ranking files responsive to the ranking in a second interface in communication with the first interface, the second interface having a second non-linear orientation.

23. The computer program product of claim 22, further comprising dividing the second interface into multiple secondary sections, assigning each open file assigned to one of the multiple secondary sections, and allocating a size of each of the secondary sections responsive to the ranking of the file.

24. The computer program product of claim 17, wherein the ranking is based on real-time content analysis selected from the group consisting of: most recently use, most actively used, frequency of use, and combinations thereof.

25. (canceled)
